(19) United States
(12) Patent Application Publication
(10) Pub. No.: US 2026/0280658 A1
(43) Pub. Date: Sep. 17, 2026

(54) COMMUNICATION PARAMETERS IN ACCORDANCE WITH CROSS-ANTENNA-MODULE COMBINING

(71) Applicant: QUALCOMM Incorporated, San Diego, CA (US)

(72) Inventors: Vasanthan RAGHAVAN, West Windsor Township, NJ (US); Jung Ho RYU, Englewood Cliffs, NJ (US); Junyi LI, Greentown, PA (US)

(21) Appl. No.: 19/080,157

(22) Filed: Mar. 14, 2025

(51) Int. Cl. H04B 7/06; H04W 28/02

(52) U.S. Cl. CPC H04B 7/0628; H04B 7/0608; H04B 7/063; H04W 28/0215

(57) ABSTRACT

Various aspects of the present disclosure generally relate to wireless communication. In some aspects, a user equipment (UE) may transmit, to a network node, capability information to enable a cross-antenna-module operation, where the cross-antenna-module operation may be associated with wireless communications using multiple antenna elements across multiple antenna modules. The UE may transmit, to the network node, a set of communication parameters associated with the cross-antenna-module operation and an in-antenna-module operation, where the in-antenna-module operation may be associated with wireless communications using a single antenna module. Numerous other aspects are described.

### FIELD OF THE DISCLOSURE

Aspects of the present disclosure generally relate to wireless communication and specifically relate to techniques, apparatuses, and methods associated with communication parameters in accordance with cross-antenna-module combining.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to transmit, to a network node, capability information to enable a cross-antenna-module combining operation, wherein the cross-antenna-module combining operation is associated with wireless communications using multiple antenna elements across multiple antenna modules in a coherent manner. The one or more processors may be configured to transmit, to the network node, a set of communication parameters associated with the cross-antenna-module combining operation and an in-antenna-module operation, wherein the in-antenna-module operation is associated with wireless communications using only a single antenna module.

Some aspects described herein relate to a network node for wireless communication. The network node may include one or more memories and one or more processors coupled to the one or more memories. The one or more processors may be configured to receive, from a UE, capability information to enable a cross-antenna-module operation, wherein the cross-antenna-module operation is associated with wireless communications using multiple antenna elements across multiple antenna modules. The one or more processors may be configured to receive, from the UE, a set of communication parameters associated with the cross-antenna-module operation and an in-antenna-module operation, wherein the in-antenna-module operation is associated with wireless communications using a single antenna module.

Some aspects described herein relate to a method of wireless communication performed by a UE. The method may include transmitting, to a network node, capability information to enable a cross-antenna-module operation, wherein the cross-antenna-module operation is associated with wireless communications using multiple antenna elements across multiple antenna modules. The method may include transmitting, to the network node, a set of communication parameters associated with the cross-antenna-module operation and an in-antenna-module operation, wherein the in-antenna-module operation is associated with wireless communications using a single antenna module.

Some aspects described herein relate to a method of wireless communication performed by a network node. The method may include receiving, from a UE, capability information to enable a cross-antenna-module operation, wherein the cross-antenna-module operation is associated with wireless communications using multiple antenna elements across multiple antenna modules. The method may include receiving, from the UE, a set of communication parameters associated with the cross-antenna-module operation and an in-antenna-module operation, wherein the in-antenna-module operation is associated with wireless communications using a single antenna module.

Some aspects described herein relate to a non-transitory computer-readable medium that stores a set of instructions for wireless communication by a UE. The set of instructions, when executed by one or more processors of the UE, may cause the UE to transmit, to a network node, capability information to enable a cross-antenna-module operation, wherein the cross-antenna-module operation is associated with wireless communications using multiple antenna elements across multiple antenna modules. The set of instructions, when executed by one or more processors of the UE, may cause the UE to transmit, to the network node, a set of communication parameters associated with the cross-antenna-module operation and an in-antenna-module operation, wherein the in-antenna-module operation is associated with wireless communications using a single antenna module.

Some aspects described herein relate to a non-transitory computer-readable medium that stores a set of instructions for wireless communication by a network node. The set of instructions, when executed by one or more processors of the network node, may cause the network node to receive, from a UE, capability information to enable a cross-antenna-module operation, wherein the cross-antenna-module operation is associated with wireless communications using multiple antenna elements across multiple antenna modules. The set of instructions, when executed by one or more processors of the network node, may cause the network node to receive, from the UE, a set of communication parameters associated with the cross-antenna-module operation and an in-antenna-module operation, wherein the in-antenna-module operation is associated with wireless communications using a single antenna module.

Some aspects described herein relate to an apparatus for wireless communication. The apparatus may include means for transmitting, to a network node, capability information to enable a cross-antenna-module operation, wherein the cross-antenna-module operation is associated with wireless communications using multiple antenna elements across multiple antenna modules. The apparatus may include means for transmitting, to the network node, a set of communication parameters associated with the cross-antenna-module operation and an in-antenna-module operation, wherein the in-antenna-module operation is associated with wireless communications using a single antenna module.

Some aspects described herein relate to an apparatus for wireless communication. The apparatus may include means for receiving, from a UE, capability information to enable a cross-antenna-module operation, wherein the cross-antenna-module operation is associated with wireless communications using multiple antenna elements across multiple antenna modules. The apparatus may include means for receiving, from the UE, a set of communication parameters associated with the cross-antenna-module operation and an in-antenna-module operation, wherein the in-antenna-module operation is associated with wireless communications using a single antenna module.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of antenna module configurations at a user equipment (UE).

FIG. 4 is a diagram illustrating an example associated with communication parameter reporting for multiple antenna module operations of a UE.

FIG. 5 is a diagram illustrating an example associated with communication parameter reporting for spectral efficiency and energy efficiency module operations of a UE.

FIG. 6 is a diagram illustrating an example associated with signaling that enables cross-antenna-module combining.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

A user equipment (UE) may include multiple antenna modules, each configured to facilitate wireless communication over various frequency bands or spatial streams. Each antenna module consists of multiple antenna elements, which may be used for transmitting and receiving signals in various wireless communication technologies. These antenna elements may enable beamforming, spatial multiplexing, and diversity techniques, improving signal strength, reliability, and spectral efficiency. Depending on the network conditions and a capability of the UE, different antenna modules may be activated or deactivated to optimize performance while minimizing power consumption.

Within an antenna module, in-antenna-module combining can be used to aggregate signals from multiple antenna elements for transmission or reception. This technique may be particularly beneficial in scenarios where signal quality varies across different antenna elements within the same module, such as low-SNR environments or multipath fading conditions. By combining signals at the module level, the UE can improve reception quality and increase robustness without requiring additional processing at the baseband level. Additionally, or alternatively, cross-antenna-module combining may involve coordinating multiple antenna elements across multiple antenna modules to enhance overall system performance. Cross-antenna-module combining may be particularly useful in MIMO (multiple-input multiple-output) and carrier aggregation scenarios, where data streams from different frequency bands or spatial paths can be efficiently combined to maximize throughput and reliability. Cross-antenna-module combining may also be beneficial in multi-beam communication, where different antenna modules operate on separate beams, allowing the UE to maintain a strong connection even in dynamic mobility conditions, such as handover between cells or beam switching. Accordingly, cross-antenna-module combining may enable the UE to transmit a higher data payload, compared to in-antenna-module combining, which may increase spectral efficiency. However, cross-antenna-module combining may increase the power consumption at the UE, which may reduce energy efficiency of wireless communications, compared to in-antenna-module combining. Additionally, or alternatively, a network node may be unaware of whether the UE is capable of cross-antenna-module combining, which may result in the network node not leveraging the potential increase in spectral efficiency associated with cross-antenna-module combining.

Various aspects relate generally to communication parameters that enable cross-antenna-module combining at a UE. Some aspects more specifically relate to a UE transmitting, and a network node receiving, capability information that enables the UE to perform cross-antenna-module combining. In some examples, the capability information may enable cross-antenna-module combining for downlink communications. Accordingly, the UE may perform subsequent channel state information (CSI) procedures that include parameters associated with both in-antenna-module combining and cross-antenna-module combining. For example, the UE may transmit a CSI report that includes a first set of CSI parameters associated with receiving downlink transmissions according to in-antenna-module combining and a second set of CSI parameters associated with receiving downlink transmissions according to cross-antenna-module combining. Therefore, the network node may determine, based on characteristics of the network environment, whether to perform subsequent downlink transmissions that leverage the increased spectral efficiency associated with cross-antenna-module combining or the reduction in energy consumption associated with in-antenna-module combining.

In some examples, the capability information may enable cross-antenna-module combining for uplink communications. Accordingly, the UE may transmit power control messages that include power control parameters associated with both in-antenna-module combining and cross-antenna-module combining. For example, the UE may transmit a power control report that includes a first set of power control parameters associated with transmitting via uplink according to in-antenna-module combining and a second set of power control parameters associated with transmitting via downlink according to cross-antenna-module combining. Therefore, the network node may determine, based on characteristics of the network environment, whether the UE should perform uplink transmissions that leverage the increased spectral efficiency associated with cross-antenna-module combining or leverage the reduction in energy consumption associated with in-antenna-module combining.

In some examples, the UE may use both cross-antenna-module combining and in-antenna-module combining to optimize one or more of spectral efficiency and energy efficiency. For example, the UE may measure multiple reference signals received from the network node using an in-antenna-module operation and a cross-antenna-module operation. Based on measuring the reference signals, the UE may determine which of the module operations is associated with an increase in spectral efficiency and which of the module operations is associated with an increase in energy efficiency. Accordingly, the UE may generate a CSI report that includes a first set of CSI parameters that emphasize increasing spectral efficiency and a second set of CSI parameters that emphasize increasing energy efficiency. Therefore, the network node may perform a CSI parameter selection that determines whether to prioritize energy efficiency or spectral efficiency based on characteristics of the network environment (e.g., link quality) or characteristics of the UE (e.g., a battery capacity).

Particular aspects of the subject matter described in this disclosure can be implemented to realize one or more of the following potential advantages. In some examples, the described techniques can be used to enable dynamic selection between multiple antenna module operations of the UE to adapt to changes in the quality of network communications. For example, based on the UE providing wireless communication parameters associated with in-antenna-module combining and cross-antenna-module combining, the network node may dynamically switch between prioritizing spectral efficiency and energy efficiency for wireless communications with the UE. Additionally, or alternatively, based on the UE indicating capability support for cross-antenna-module combining, the network node may leverage the increased spectral efficiency and data payload size associated with cross-antenna-module combining, increasing a utilization of wireless communication resources.

5G New Radio (NR) may support enhanced mobile broadband (eMBB) access, Internet of Things (IOT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

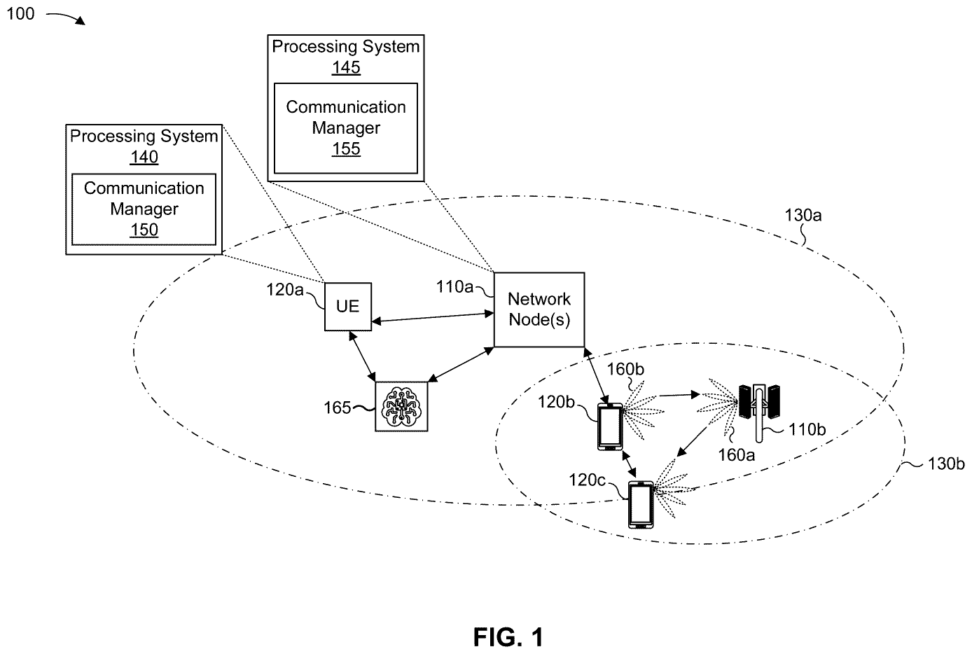

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IOT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

An antenna panel, an antenna group, or an antenna array may include one or more antenna elements (within a single housing or multiple housings), one or more coplanar antenna elements, one or more non-coplanar antenna elements, or one or more antenna elements coupled with one or more transmission or reception components, such as the processing system 140 or the processing system 145. “Antenna element” refers to single radiating (for example, transmitting) or receiving point included in an antenna array. An antenna array may also be referred to as a “sub-array.” An antenna array may include one or more antenna elements where each antenna element is configured as a single unit for radiating (for example, transmitting) or receiving, In some examples, each of the antenna elements of an antenna may include one or more sub-elements for radiating or transmitting or receiving RF signals. A “sub-element” refers to an individual component (e.g., an individually controllable component) within an antenna element, such as an individual radiating unit. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively or destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers or phases of the signal(s) to form one or more beams. The shape of a beam (such as the amplitude, width, or presence of side lobes) or the direction of a beam (such as an angle of the beam relative to a surface of an antenna array) can be dynamically controlled by modifying the phase shifts, phase offsets, or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Advantages of using a larger number of antenna elements may include providing increased control over parameters for beam generation relative to a smaller number of antenna elements, whereas advantages of using a smaller number of antenna elements may include reducing implementation complexity, or reduced power consumption compared to use of a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Advancements in antenna designs may be driven by the need for faster data rates, lower latency, or more reliable connectivity in advanced/next-generation systems, such as 6G systems, massive multiple-input multiple-output (massive MIMO) systems, among other examples. For example, the wireless communication network 100 may operate using higher frequency bands, such as millimeter wave frequencies or terahertz (THz) frequencies, which enable faster data transmissions and increased bandwidth. To enable UEs 120 and network nodes 110 to communicate using these higher frequency bands, antennas (or antenna elements) of the UEs 120 and network nodes 110 may be configured to address the increased signal attenuation or limited range associated with these higher frequency bands. For example, a UE 120 or a network node 110 may use advanced beamforming techniques, such as AI/ML-based beamforming techniques (for example, in which an AI/ML model can be used to dynamically adjust beamforming patterns in response to changing network conditions, channel conditions, or UE location, among other examples, to improve signal strength or reduce interference). Additionally, the antennas may have a higher density of antenna elements (e.g., as compared to conventional antenna configurations) to enable more precise beam steering or to increase the quantity of independent beams that can be formed simultaneously using an antenna panel (thereby supporting an increased quantity of simultaneous connections). Additionally, the wireless communication network 100 may include one or more devices that have dynamically configurable antenna panels or antenna elements (for example, for an intelligent reflecting surface (IRS) or a reconfigurable intelligent surface (RIS)) to improve coverage and signal strength.

Further efficiencies in throughput, signal strength, or other signal properties may be achieved through beam refinement. For example, the network node 110 may be capable of communicating with the UE 120 using beams (for example, beam(s) 160a) of different beamwidths. In some examples, the network node 110 may be configured to utilize a wider beamwidth beam (for example, a beam having a larger beamwidth) to communicate with the UE 120 when the UE 120 is in motion or for initial beam acquisition because wider coverage may increase the likelihood that the UE 120 remains in coverage of the network node 110 while communicating using the wider beamwidth beam. Conversely, the network node 110 may use a narrower beamwidth beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beamwidth beams, whereas CSI-RSs may be transmitted on narrower beamwidth beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some examples, a UE 120 or a network node 110 may use an inference model (for example, an AI/ML model) to obtain one or more inferences or predictions for beamforming. An output of the inference model may include a codebook based spatial domain selection or prediction (for example, that indicates one or more predicted measurement values for one or more beams) or a non-codebook based spatial domain selection or prediction (for example, that indicates one or more parameters for a beam, such as a point-direction, an angle of departure (AoD), or an angle of arrival (AoA), among other examples). The UE 120 or the network node 110 may configure one or more antenna elements to form one or more beams in accordance with the output of the inference model.

In some aspects, the UE 120 may include a communication manager 150. As described in more detail elsewhere herein, the communication manager 150 may transmit, to a network node, capability information to enable a cross-antenna-module operation, wherein the cross-antenna-module operation is associated with wireless communications using multiple antenna elements across multiple antenna modules; and transmit, to the network node, a set of communication parameters associated with the cross-antenna-module operation and an in-antenna-module operation, wherein the in-antenna-module operation is associated with wireless communications using a single antenna module. Additionally, or alternatively, the communication manager 150 may perform one or more other operations described herein.

In some aspects, the network node 110 may include a communication manager 155. As described in more detail elsewhere herein, the communication manager 155 may receive, from a UE, capability information to enable a cross-antenna-module operation, wherein the cross-antenna-module operation is associated with wireless communications using multiple antenna elements across multiple antenna modules; and receive, from the UE, a set of communication parameters associated with the cross-antenna-module operation and an in-antenna-module operation, wherein the in-antenna-module operation is associated with wireless communications using a single antenna module. Additionally, or alternatively, the communication manager 155 may perform one or more other operations described herein.

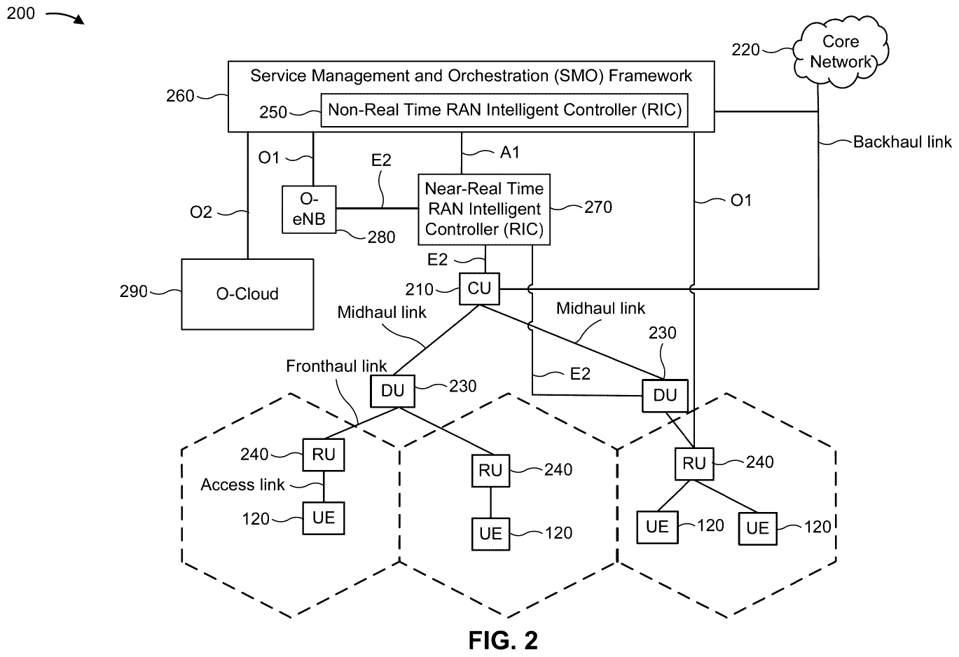

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an 02 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

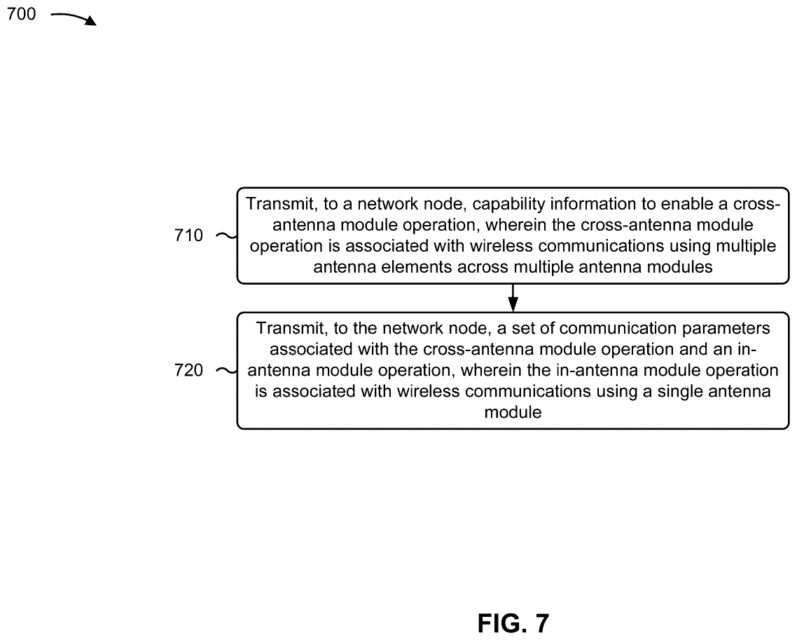

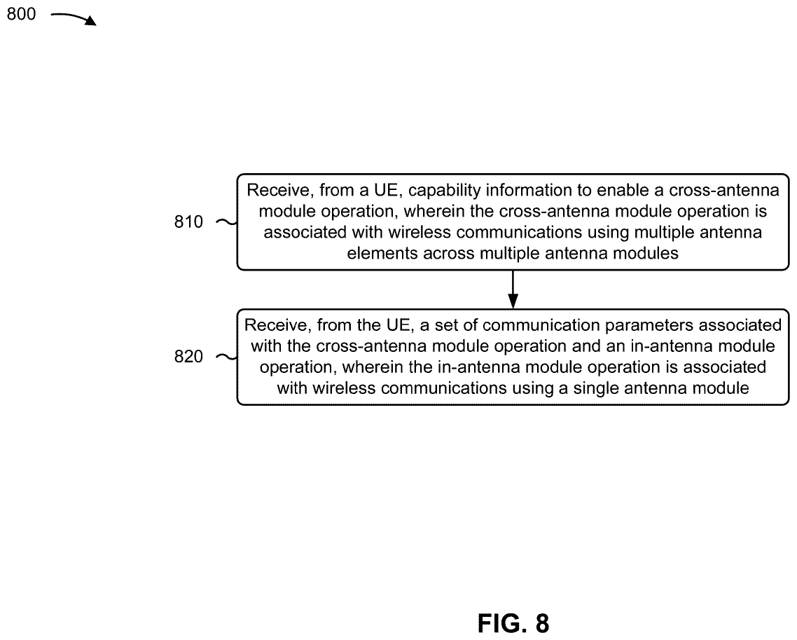

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with communication parameters in accordance with cross-antenna-module combining, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

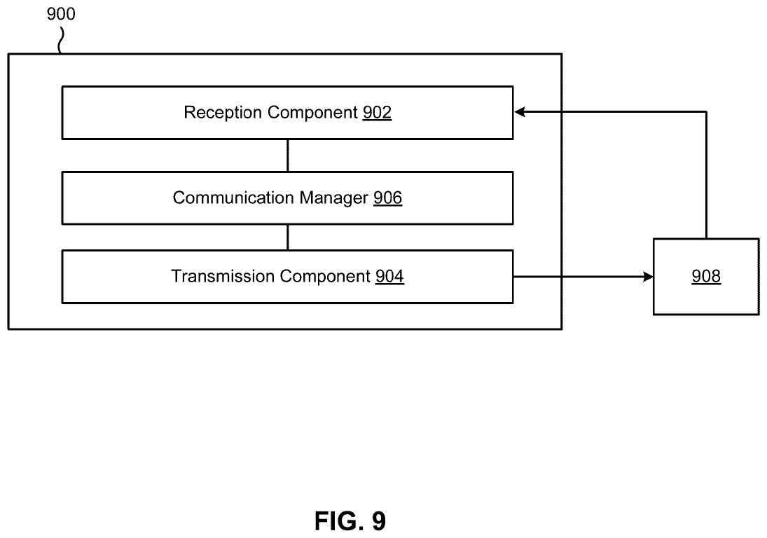

In some aspects, the UE 120 includes means for transmitting, to a network node, capability information to enable a cross-antenna-module operation, wherein the cross-antenna-module operation is associated with wireless communications using multiple antenna elements across multiple antenna modules; or means for transmitting, to the network node, a set of communication parameters associated with the cross-antenna-module operation and an in-antenna-module operation, wherein the in-antenna-module operation is associated with wireless communications using a single antenna module. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

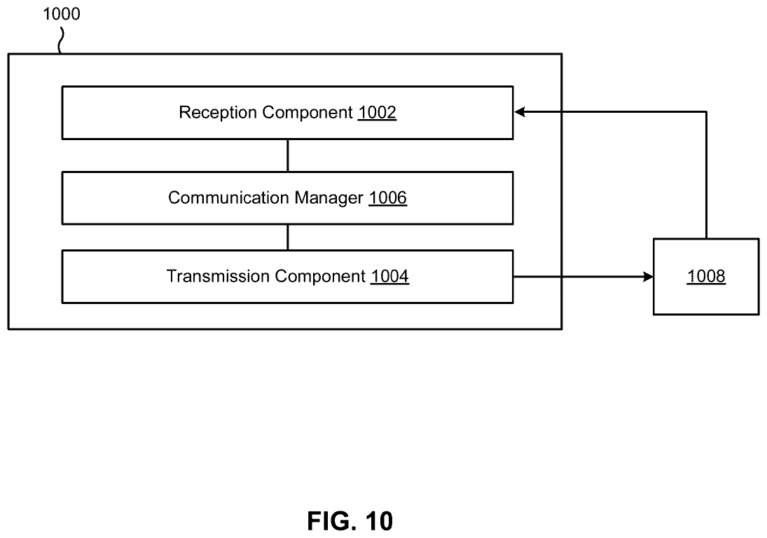

In some aspects, the network node 110 includes means for receiving, from a UE, capability information to enable a cross-antenna-module operation, wherein the cross-antenna-module operation is associated with wireless communications using multiple antenna elements across multiple antenna modules; or means for receiving, from the UE, a set of communication parameters associated with the cross-antenna-module operation and an in-antenna-module operation, wherein the in-antenna-module operation is associated with wireless communications using a single antenna module. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

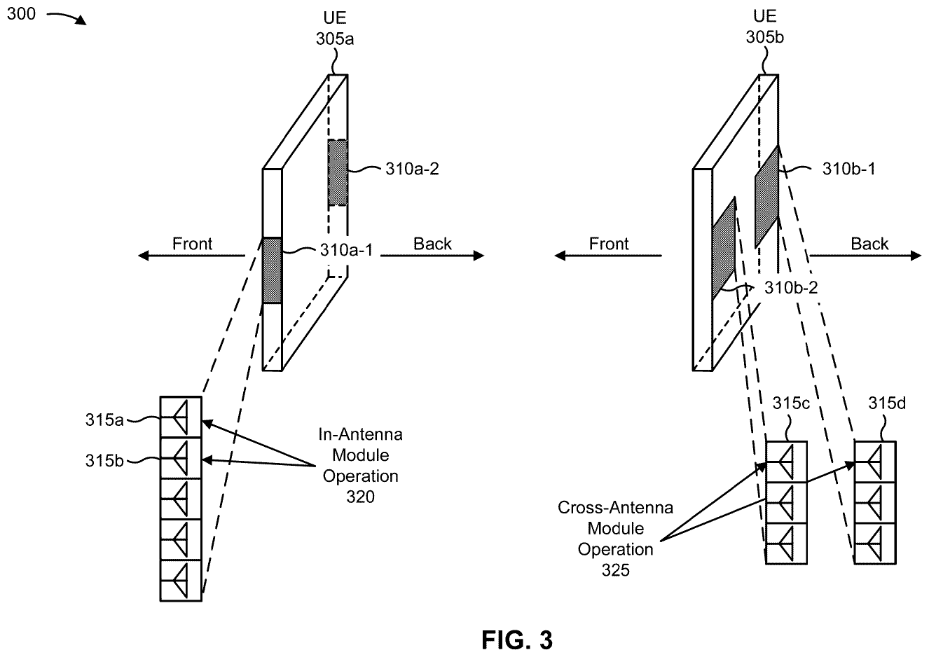

FIG. 3 is a diagram illustrating an example 300 of antenna module configurations at a UE. In some instances, example 300 may implement or be implemented by one or more aspects of FIGS. 1 and 2. For instance, FIG. 3 shows a UE 305a and a UE 305b, which may be respective examples a UE 120, described elsewhere herein.

As shown in FIG. 3, the UEs 305 may include multiple antenna modules 310. For example, the UE 305a may include antenna modules 310a (e.g., antenna module 310a-1 and 310a-2) and the UE 305b may include antenna modules 310b (e.g., antenna module 310b-1 and 310b-2). In some examples, an antenna module 310 may be a compact unit that integrates multiple antenna elements 315 and supports components to facilitate transmission and reception of wireless signals at a UE 305. The antenna modules 310 may enable the UEs 305 to perform analog or radio frequency (RF) beamforming, such that the UEs 305 may support wireless communications via FR2 and FR3. In some examples, an antenna module 310 may be referred to herein as an “antenna panel.”

As shown in FIG. 3, the UE 305a may include the antenna modules 310a on respective thin edges of the UE 305a (e.g., the antenna module 310a-1 on the right edge of the UE 305a and the antenna module 310a-2 on the left edge of the UE 305a). In example 300, the antenna modules 310a have an array size of 5×1; however, in other examples, the antenna modules 310 may have a different array size (such as 4×1 or 3×1, among other examples).

As shown in FIG. 3, the antenna modules 310b are included on the back face of the UE 305b (e.g., the antenna module 310b-1 on the center right portion of the back face and the antenna module 310b-2 on the center left portion of the back face). In example 300, the antenna modules 310b have an array size of 3×1; however, in other examples, the antenna modules 310b may have a different array size (such as 1×2, 3×1, 4×1, 2×2, 2×3, 3×3, 3×4, among other examples). In some examples, placement of the antenna modules on the back face of the UE 305b may enable dual-polarization techniques for FR3-based wireless communications. For example, “dual-polarization” in FR3 may refer to the use of two orthogonal polarizations within an antenna system, which may enable the communication of two independent signals on the same frequency band, effectively doubling the data throughput without increasing the frequency bandwidth. In some examples, dual-polarization enables rank-2 or higher MIMO configurations (e.g., 2×2, 4×4, or 8×8 MIMO, among other examples).

In some examples, an antenna module 310 may be selected from a set of antenna modules 310 at a UE to enable MIMO operations. For instance, in the example 300, the antenna module 310a-1 may be enabled for rank-2 polarization MIMO operations. The rank of a MIMO channel may refer to the number of independent data streams that can be communicated concurrently by a UE. For instance, a rank-2 MIMO system may enable the communication (transmission or reception) of two independent data streams. Additionally, different antenna elements 315 may communicate wireless signals on different orthogonal polarizations. For instance, an antenna element 315a may communicate a first data stream according to a vertical polarization concurrently to an antenna element 315b communicating a second data stream according to a horizontal polarization. Rank-2 polarization MIMO may be an example of an in-antenna-module operation 320, where multiple antenna elements 315 within a single antenna module 310 may be used to perform MIMO operations. In some examples, the in-antenna-module operation 320 may be referred to herein as one or more of “in-module combining”, an “in-module scheme”, “inter-antenna-module combining”, or a combination of such phrases.

In some examples, multiple antenna elements 315 from multiple antenna modules 310 of a UE may be selected to enable MIMO operations. For instance, in the example 300, an antenna element 315c may be selected from the antenna module 310b-2 and an antenna element 315d may be selected from the antenna module 310b-1. Accordingly, the antenna element 315c may communicate a first data stream according to a vertical polarization concurrently to an antenna element 315d communicating a second data stream according to a horizontal polarization. Concurrent data stream communications across multiple antenna modules 310 may be an example of a cross-antenna-module operation 325. In some examples, cross-antenna-module operation 325 may achieve a higher MIMO rank compared to the in-antenna-module operation 320 (e.g., cross-module rank≤2k, where k is the number of antenna modules 310 at a UE). In some examples, the cross-antenna-module operation 325 may be referred to herein as one or more of “cross-module combining”, a “cross-module scheme”, “cross-antenna-module combining”, or a combination of such phrases.

The in-antenna-module operation 320 and the cross-antenna-module operation 325 may be associated with different benefits for performance of a given UE. For instance, with reference to the in-antenna-module operation 320, multiple radiating antenna elements 315 within the same antenna module are combined before being passed to a transceiver or RF front-end of the associated UE. Additionally, in accordance with the in-antenna-module operation 320, each antenna module of the given UE processes signals independently, reducing interconnect complexity.

Additionally, because signals may be combined at the antenna module level for the in-antenna-module operation 320, the given UE may use fewer antenna elements 315 or RF chains, reducing power consumption. Conversely, in accordance with the cross-antenna-module operation 325, rather than combining signals within different antenna modules 310 separately, the given UE 305 may process signals from different antenna modules together. Accordingly, combing antenna elements 315 across multiple antenna modules 310 may reduce interference associated with wireless communications and may increase the precision of beam control management at the given UE. However, the cross-antenna-module operation 325 may use more RF chains, because each antenna module sends independent signals to the baseband, which may increase power consumption at the given UE. Accordingly, the cross-antenna-module operation 325 may result in an increased performance of the given UE, compared to the in-antenna-module operation 320, and the in-antenna-module operation 320 may be associated with reduced power consumption, compared to the cross-antenna-module operation 325.

Additionally, a UE may transmit CSI metrics (e.g., one or more of RI, PMI, or CQI) to a network node (e.g., a network node 110 described elsewhere herein). A UE may determine such CSI metrics in order to increase a data rate or spectral efficiency for wireless communications between the UE and the network node. In some cases, however, the CSI metrics may not be associated with increasing energy efficiency for the wireless communications between the UE and the network node. In some examples, energy savings and energy efficiency may both be important aspects of wireless communication design (such as 5G and 6G). For instance, as described herein, the cross-antenna-module operation 325 may be associated with higher data rates, compared to the in-antenna-module operation 320, but may additionally increase power consumption. In some examples, a UE 305 may operate in accordance with multiple energy states that balance performance and energy efficiency associated with the UE 305. For example, a UE 305 may operate in accordance with a “performance optimized state” that may be associated with higher data rates, or spectral efficiency and higher power consumption. Additionally, or alternatively, a UE 305 may operate in accordance with an “energy saving state” that may be associated with a reduction in power consumption at the UE and a reduction in data rates or spectral efficiency. Accordingly, the UE may use an increased antenna capability during the performance-optimized state (e.g., use the cross-antenna-module operation 325) and may scale down antenna capabilities in the energy saving state. A UE may transmit the CSI metrices (e.g., PMI, CQI, and RI) in accordance with the current operating energy state of the UE. In some examples, the energy state that a UE 305 operates in accordance with may change relatively slowly over time (e.g., a UE may operate in a same energy state for multiple wireless communications or across multiple contiguous slots).

In some examples, a UE 305 may determine a data rate (R) associated with the in-antenna-module operation 320 and the cross-antenna-module operation 325. For instance, with reference to the in-antenna-module operation 320, the UE 305b may measure a first data rate for the antenna module 310b-1 and measure the second date rate for the antenna module 310b-2, where the greater data rate between the first data rate and the second data rate may be the data rate associated with the in-antenna-module operation 320 (R_{in-module}). With reference to the cross-antenna-module operation 325, the UE may measure a data rate achieved by combining antenna elements 315 across the antenna module 310b-1 and 310b-2 (R_{cross-module}).

In some examples, the UE may determine energy efficiency (EE) associated with the in-antenna-module operation 320 and the cross-antenna-module operation. For instance, with reference to the in-antenna-module operation 320, the UE 305b may measure a current consumption (I_{in-module}) associated with selecting the antenna module 310b and antenna elements 315 that achieve R_{in-module}. Accordingly, the UE 305b may determine the EE for the in-antenna-module operation 320 (EE_{in-module}) based on the values of R_{in-module}, I_{in-module}, and a voltage level (V) at the UE 305b (e.g., EE_{in-module}=R_{in-module}/(V×I_{in-module})). With reference to the cross-antenna-module operation 325, the UE 305b may measure a current consumption (I_{cross-module}) associated with selecting the antenna elements 315 across both antenna module 310b-1 and 310b-2 that achieve R_{cross-module}. Accordingly, the UE 305b may determine the EE for the cross-antenna-module operation 325 (EE_{cross-module}) based on the values of R_{cross-module}, I_{cross-module}, and a voltage level (V) at the UE 305b (e.g., EE_{cross-module}=R_{cross-module}/(V×I_{cross-module})).

In some examples, R_{cross-module} may be expected to be greater than R_{in-module} based on the increases in spectral efficiency and data rate associated with the cross-antenna-module operation 325. However, whether EE_{in-module} is greater than or less than EE_{cross-module} may be based on the RF architecture of the UE 305b. For example, as the number of antenna elements 315 used for the in-antenna-module operation 320 or the cross-antenna-module operation 325 increases, the ratio between R_{cross-module} and I_{cross-module} may increase faster than the ratio between R_{in-module} and I_{in-module}. In other words, EE_{cross-module} may increase at a faster rate compared to EE_{cross-module} as the number of antenna elements 315 used by the UE 305b increases. Therefore, whether the EE_{in-module} or EE_{cross-module} is higher may change based on the number of antenna elements 315 used to perform wireless communications. Additionally, or alternatively, the rate at which EE_{cross-module} increases relative to EE_{in-module} may be different for downlink reception and uplink transmission. For instance, as the number of antenna elements 315 used increases, EE_{cross-module} may increase relative to EE_{in-module} faster for uplink transmissions compared to downlink receptions, or vice versa.

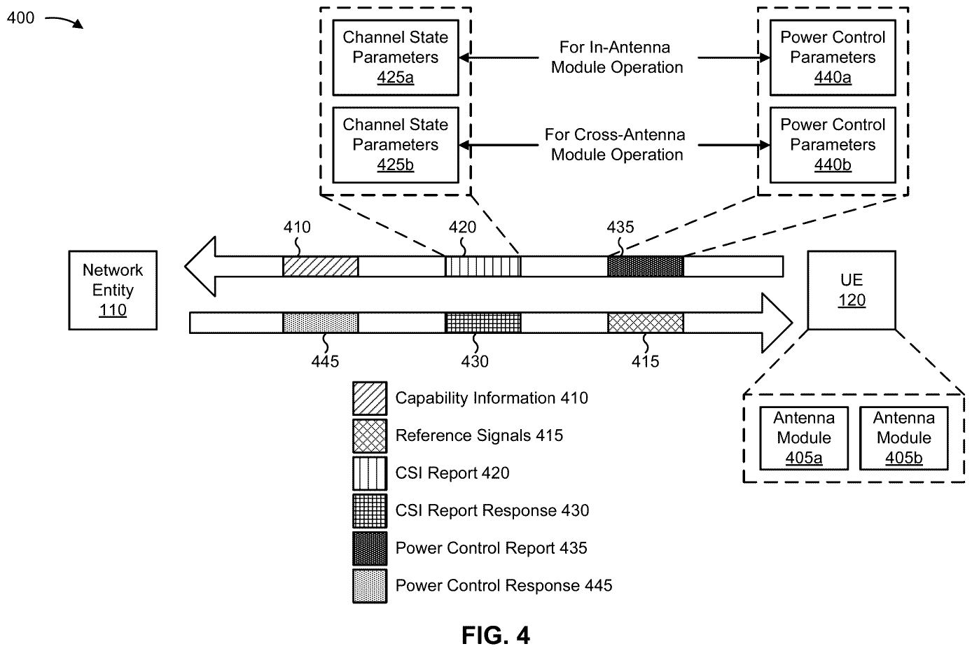

FIG. 4 is a diagram illustrating an example 400 associated with communication parameter reporting for multiple antenna module operations of a UE 120. In some instances, example 400 may implement or be implemented by one or more aspects of FIGS. 1 through 4. For instance, FIG. 4 shows wireless communications between the UE 120 and the network node 110, as described elsewhere herein. In some examples, the UE 120 may include multiple antenna modules 405 (e.g., antenna module 405a and 405b), which may be examples of the antenna modules 310 described with reference to FIG. 3. Accordingly, the UE 120 of example 400 may be capable of both the in-antenna-module operation 320 and the cross-antenna-module operation 325, as described with reference to FIG. 3.

As shown in FIG. 4, the UE 120 may transmit, and the network node 110 may receive, capability information 410. For example, the capability information 410 may be a capability report, where the UE 120 declares a capability to network node 110 to enable cross-antenna-module operation as a power-performance feature of the UE 120. In other words, the capability information 410 may indicate that the UE 120 supports cross-antenna-module operation in addition to in-antenna-module operation. In some examples, the capability information may enable the cross-antenna-module operation at the UE 120 for one or more of uplink (e.g., transmissions to the network node 110 from the UE 120) or downlink (e.g., transmissions to the UE 120 from the network node 110). In some examples, the capability information 410 may indicate how much performance improvement is expected for the cross-antenna-module operation compared to the in-antenna-module operation. For example, the UE 120 may indicate the performance improvement by indicating a data rate percentage increase for one or more of the uplink data rate or downlink data rate relative to the in-antenna-module operation. In some examples, the UE 120 may determine the data rate percentage increase based on a comparison with a database. In some examples, the capability information 410 may indicate how much power increase is expected for the cross-antenna-module operation compared to the in-antenna-module operation. For example, the UE 120 may indicate the power increase by indicating a power percentage increase for one or more of the uplink direction or downlink direction relative to the in-antenna-module operation. In some examples, the power percentage increase may be quantized with reference to a quantization range.

In accordance with indicating support for the cross-antenna-module operation via the capability information 410, performance at the UE 120 may be increased in terms of one or more of an uplink data rate or a downlink data rate.

To enhance the downlink data rate, the UE 120 may transmit, and the network node 110 may receive, a CSI report 420. For example, the CSI report may include channel state parameters 425a and channel state parameters 425b. As shown in FIG. 4, the channel state parameters 425a may include a first PMI, one or more first CQIs, and a first RI that applies to in-antenna-module combining at the UE 120 (e.g., combining antenna elements of the antenna module 405a or combining antenna elements of the antenna module 405b to receive downlink transmissions). Additionally, as shown in FIG. 4, the channel state parameters 425b may include a second PMI, one or more second CQIs, and a second RI that applies to cross-antenna-module combining at the UE 120 (e.g., combining antenna elements across both the antenna module 405a and 405b to receive downlink transmissions). In some examples, the UE 120 may indicate CQI on a per-layer basis, where the number of layers is equal to the associated RI. For instance, if the first RI is two, then the one or more first CQIs may include a first CQI for the first layer and a second CQI for the second layer. Additionally, or alternatively, if the second RI is four, then the one or more second CQIs may include a first CQI for the first layer, a second CQI for the second layer, a third CQI for the third layer, and a fourth CQI for the fourth layer. In an example where the first RI and the second RI are both equal to one, a first SNR measured for the layer according to the cross-antenna-module operation may be higher compared to a second SNR measured for the layer according to the in-antenna-module operation. Accordingly, in such an example, the first CQI of the channel state parameters 425a may be higher compared to the second CQI of the channel state parameters 425b.

In some examples of CSI reporting, the UE 120 may indicate a CSI resource indicator (CRI) or an SSB resource indicator (SSBRI) and the associated channel information. For example, the UE 120 may report RSRP measurements of a CSI-RS such that the CSI report 420 may include an RSRP value and the CSI referring to the CSI-RS that the UE 120 received to measure the RSRP. A CRI may be an indicator associated with a CSI-RS received by the UE 120 from the network node 110. An SSBRI may be an indicator associated with an SSB received by the UE 120 from the network node 110.

In some examples, as part of generating the CSI report 420, the network node 110 may transmit, and the UE 120 may receive, one or more reference signals 415. For example, the UE 120 may receive a first reference signal of the one or more reference signals 415 via the antenna module 405a and may receive a second reference signal of the one or more reference signals 415 via the antenna module 405b. In some examples, the first reference signal may be associated with a first indicator (e.g., a first CRI if the first reference signal is a first CSI-RS or a first SSBRI if the first reference signal is a first SSB). In some examples, the second reference signal may be associated with a second indicator (e.g., a second CRI if the second reference signal is a second CSI-RS or a second SSBRI if the second reference signal is a second SSB). If the UE 120 performs cross-antenna-module operation across the antenna modules 405a and 405b, then the CSI report 420 may include two or more CRIs or SSBRIs, or a combination of CRIs and SSBRIs. For example, the channel state parameters 425b may include both the first indicator associated with the first reference signal (e.g., the first CRI or first SSBRI) and the second indicator associated with the second reference signal. Additionally, or alternatively, the channel state parameters 425a may include the first indicator associated with the first reference signal (e.g., the first CRI or first SSBRI) if the channel state parameters 425a are associated with the antenna module 405a or the channel state parameters 425a may include the second indicator associated with the second reference signal (e.g., the second CRI or second SSBRI) if the channel state parameters 425a are associated with the antenna module 405b.

In some examples, the network node 110 may transmit, and the UE 120 may receive, a CSI report response 430 that may be associated with the CSI report 420. For example, the CSI report response 430 may indicate whether the UE 120 should operate in accordance with the channel state parameters 425a or operate in accordance with the channel state parameters 425b. Therefore, if the network node 110 indicates the channel state parameters 425a, then the UE 120 may receive one or more subsequent downlink transmissions via the in-antenna-module operation, and if the network node 110 indicates the channel state parameters 425b, then the UE 120 may receive one or more subsequent downlink transmissions via the cross-antenna-module operation.

To enhance the uplink data rate, the UE 120 may transmit, and the network node 110 may receive, a power control report 435. For example, the power control report 435 may include power control parameters 440a and power control parameters 440b. As shown in FIG. 4, the power control parameters 440a may apply for uplink transmissions using the in-antenna-module operation at the UE 120 (e.g., combining antenna elements of the antenna module 405a or combining antenna elements of the antenna module 405b to transmit uplink transmissions). Additionally, as shown in FIG. 4, the power control parameters 440b may apply for uplink transmissions using the cross-antenna-module operation at the UE 120 (e.g., combining antenna elements across both the antenna module 405a and 405b to transmit uplink transmissions).

In some examples, the power control parameters 440a and 440b may indicate one or more parameters corresponding to Equation 1:

$${P}_{PUSCH} ( i ) = min \{ {P}_{CMAX , UE} , 10 {log}_{10} ( {M}_{PUSCH} ( i ) ) + {P}_{O\_PUSCH} ( j ) + α ( j ) \cdot PL + {Δ}_{TF} ( i ) + f ( i ) \} \qquad ( 1 )$$

where the value P_{CMAX,UE} is a maximum power output for the UE 120 for a carrier (f) and a cell (c), the value 10 log₁₀ (M_{PUSCH}(i)) indicates a number of resource blocks or resource elements configured for an uplink transmission occasion (i), the value P_{O_PUSCH}(j) is a target reception power at the network node 110, the value α(j)·PL is a path loss associated with uplink transmissions from the UE 120 to the network node 110, the value Δ_{TF}(i) is a transmission format for uplink transmission occasion (i) (e.g., indicate an MCS associated with uplink), and the value ƒ(i) is a closed loop power control value. Further discussion of the parameters of Equation 1 may be defined in a wireless communications standard, such as 3GPP (e.g., technical specification (TS) 38.213, v15.2.0, Section 7.1.1). In some examples, pathloss (e.g., α(j)·PL) may include propagation loss and array gain due to beamforming. In some examples, propagation loss may be a function of carrier frequency. In some examples, array gain may be a function of carrier frequency based on a fixed inter-antenna element spacing configured in an antenna module 405. In some examples, α(j) may be an optimization parameter between 0 and 1, where α(j)=0 if interference associated with uplink satisfies an interference threshold (e.g., high interference) and α(j)=1 to compensate for pathloss between the network node 110 and the UE 120.

In some examples, the power control parameters 440a may indicate one or more of a first M_{PUSCH} (i) value, a first Δ_{TF}(i) value, or a first ƒ(i) value for the in-antenna-module operation. In some examples, the power control parameters 440b may indicate one or more of a second M_{PUSCH} (i) value, a second Δ_{TF}(i) value, or a second ƒ(i) value for the cross-antenna-module operation.

In some examples, the network node 110 may transmit, and the UE 120 may receive, a power control response 445 that may be associated with the power control report 435. For example, the power control response 445 may indicate whether the UE 120 should operate in accordance with the power control parameters 440a or operate in accordance with the power control parameters 440b. Therefore, if the network node 110 indicates the power control parameters 440a, then the UE 120 may transmit one or more subsequent uplink transmissions via the in-antenna-module operation, and if the network node 110 indicates the power control parameters 440b, then the UE 120 may transmit one or more subsequent uplink transmissions via the cross-antenna-module operation.

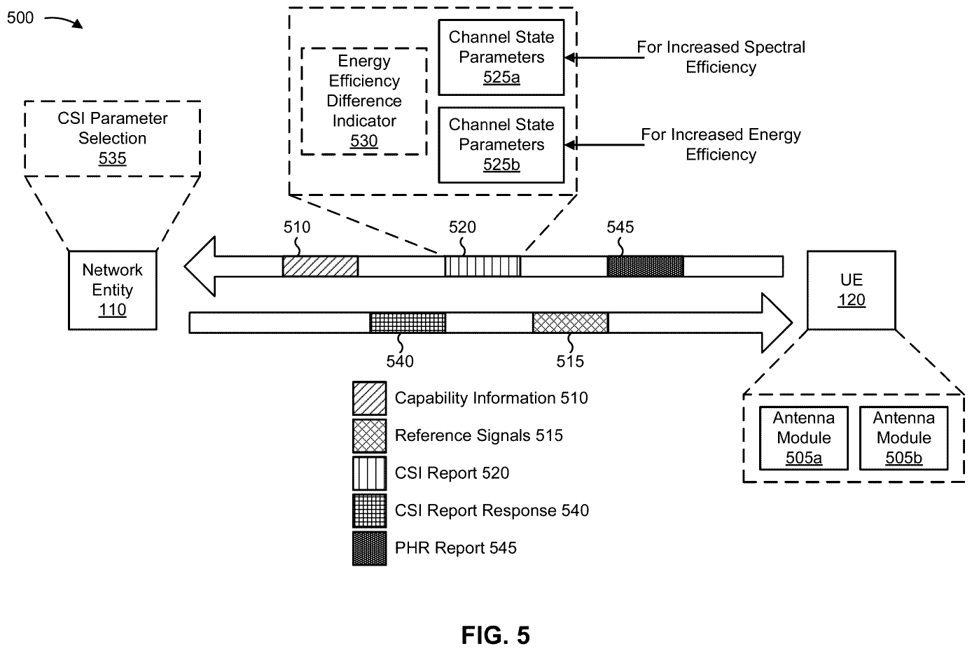

FIG. 5 is a diagram illustrating an example 500 associated with communication parameter reporting for spectral efficiency and energy efficiency module operations of a UE 120. In some instances, example 500 may implement or be implemented by one or more aspects of FIGS. 1 through 4. For instance, FIG. 5 shows wireless communications between the UE 120 and the network node 110, as described elsewhere herein. In some examples, the UE 120 may include multiple antenna modules 505 (e.g., antenna modules 505a and 505b) which may be examples of the antenna modules 310 described with reference to FIG. 3. Accordingly, the UE 120 of example 500 may be capable of both the in-antenna-module operation 320 and the cross-antenna-module operation 325, as described with reference to FIG. 3.

As shown in FIG. 5, the UE 120 may transmit, and the network node 110 may receive, capability information 510. In some examples, capability information 510 may be the capability information 410. For example, the capability information 510 may indicate that the UE 120 supports cross-antenna-module operation in addition to in-antenna-module operation.

As shown in FIG. 5, the network node 110 may transmit, and the UE 120 may receive, one or more reference signals 515. In some examples, the one or more reference signals 515 may be the one or more reference signals 415. For example, the UE 120 may receive a first reference signal (e.g., a first CSI-RS or a first SSB) via the antenna module 505a, and may receive a second reference signaled (e.g., a second CSI-RS or a second SSB) via the antenna module 505b. In some other examples, the UE 120 may receive multiple reference signals at the antenna module 505a and the antenna module 505b.

In accordance with receiving the one or more reference signals 515, the UE 120 may generate a CSI report 520 that includes channel state parameters 525 associated with spectral efficiency and energy efficiency for wireless communications between the UE 120 and the network node 110. For example, the CSI report 520 may include channel state parameters 525a associated with optimizing or increasing spectral efficiency and channel state parameters 525b associated with optimizing or increasing energy efficiency.

In some examples, the channel state parameters 525a may be associated with one of the in-antenna-module operation or the cross-antenna-module operation that results in a higher spectral efficiency. For example, based on receiving and measuring the one or more reference signals 515, the UE 120 may calculate the data rate associated with the in-antenna-module operation (R_{in-module}) and calculate the data rate associated with the cross-antenna-module operation (R_{cross-module}). Accordingly, the UE 120 may select channel state parameters 525a associated with which module operation between the in-antenna-module operation or the cross-antenna-module operation has the higher data rate. In some examples, the channel state parameters 525a may include a first PMI, a first CQI, and a first RI associated with cross-antenna-module operation if R_{cross-module}>R_{in-module} or associated with in-antenna-module operation if R_{in-module}>R_{cross-module}.

In some examples, the channel state parameters 525b may be associated with one of the in-antenna-module operation or the cross-antenna-module operation that results in a higher energy efficiency. For example, based on receiving and measuring the one or more reference signals 515, the UE 120 may calculate the energy associated with the in-antenna-module operation (EE_{in-module}=R_{in-module}/(V×I_{in-module})) and calculate the energy efficiency associated with the cross-antenna-module operation (EE_{cross-module}=R_{cross-module}/(V×I_{cross-module})). Accordingly, the UE 120 may select channel state parameters 525b associated with which module operation between the in-antenna-module operation or the cross-antenna-module operation has the higher energy efficiency. In some examples, the channel state parameters 525a may include a second PMI, a second CQI, and a second RI associated with cross-antenna-module operation if EE_{cross-module}>EE_{in-module} or associated with in-antenna-module operation if EE_{in-module}>EE_{cross-module}.

In some examples, the CSI report 520 may be associated with downlink or uplink. If the CSI report 520 is associated with downlink, then the channel state parameters 525a are for optimizing spectral efficiency associated with downlink transmissions and may include the first PMI, the first CQI, and the first RI, and the channel state parameters 525b are for energy efficiency optimization associated with downlink transmissions and may include the second PMI, the second CQI, and the second RI. If the CSI report 520 is associated with uplink, then the channel state parameters 525a are for spectral efficiency optimization associated with uplink transmissions and may include the first CQI and the first RI, and the channel state parameters 525b are for energy efficiency optimization associated with uplink transmissions and may include the second CQI and the second RI.

In addition to the channel state parameters 525a and 525b, the CSI report 520 may optionally include an energy efficiency difference indicator 530. For example, the energy efficiency difference indicator 530 may indicate an energy efficiency decrease of downlink transmissions using the channel state parameters 525a relative to using the channel state parameters 525b. In some examples, the energy efficiency difference indicator 530 may be quantized and conveyed via a set of bits. In some examples, the energy efficiency difference indicator 530 may indicate a percentage decrease in the energy efficiency between the channel state parameters 525a and the channel state parameters 525b.

Based on receiving the CSI report 520, the network node 110 may perform a CSI parameter selection 535. As part of the CSI parameter selection 535, the network node 110 may determine whether uplink or downlink transmissions should correspond to optimizing spectral efficiency (e.g., associated with the channel state parameters 525a) or should correspond to optimizing energy efficiency (e.g., associated with the channel state parameters 525b). In some examples, the CSI parameter selection 535 may be based on a data payload from the network node 110 to the UE 120. For example, if the payload size of a future downlink transmission is greater than or equal to a payload threshold, then the network node 110 may prioritize energy efficiency (e.g., select to operate in accordance with the channel state parameters 525b). If the payload size of a future downlink transmission is less than the payload threshold, then the network node 110 may prioritize spectral efficiency (e.g., select to operate in accordance with the channel state parameters 525a). Additionally, or alternatively, the CSI parameter selection 535 may be based on one or more metrics of the UE 120 (e.g., an available battery power, among other examples). For example, if the available battery power at the UE 120 is greater than or equal to a battery power threshold, then the network node 110 may prioritize spectral efficiency (e.g., select to operate in accordance with the channel state parameters 525a) and if the available battery power at the UE 120 is less than the battery power threshold, then the network node 110 may prioritize energy efficiency (e.g., select to operate in accordance with the channel state parameters 525b).

Based on the CSI parameter selection 535, the network node 110 may transmit, and the UE 120 may receive, a CSI report response 540 that indicates whether subsequent wireless communications should be in accordance with the channel state parameters 525a or the channel state parameters 525b. In some examples, the network node 110 may indicate the same set of channel state parameters 525 jointly for uplink and downlink. In some examples, the network node 110 may indicate the channel state parameters 525 separately for uplink and downlink. For instance, the CSI report response 540 may indicate that the UE 120 should transmit uplink transmissions in accordance with the channel state parameters 525a and receive downlink transmissions in accordance with the channel state parameters 525b.

In some examples, the UE 120 may transmit, and the network node 110 may receive, a power headroom (PHR) report 545. For example, the PHR report 545 may indicate a PHR associated with performing uplink transmissions in accordance with the cross-antenna-module operation. An indication of PHR may provide the network node 110 with information about the uplink transmission power capability of the UE 120. Accordingly, PHR enables the network node 110 to optimize uplink resource allocation by ensuring that the UE 120 does not exceed a maximum transmission power while maintaining an efficient link budget. The PHR may be defined as a difference between a maximum available transmission power of the UE 120 and the power that the UE 120 is currently using for an uplink transmission. The UE may report a PHR to a serving cell of the network node 110 so that the network node 110 can make scheduling decisions regarding uplink transmission, power control, and resource allocation.

In some examples, PHR may be associated with one or more types. For example, PHR Type 1 (PHR₁) may be a PUSCH-based PHR in accordance with Equation 2:

$${PHR}_{1} = {P}_{CMAX , UE} - {P}_{PUSCH} \qquad ( 2 )$$

where the value P_{CMAX,UE} is the maximum transmission power of the UE 120 (e.g., as referenced in Equation 1) and the value P_{PUSCH} is the transmit power used for a PUSCH transmission or a virtual PUSCH transmission (e.g., with configured default parameters such as a number of resource blocks, a pathloss reference signal (PL-RS), among other examples. Additionally, or alternatively, PHR Type 2 (PHR₂) may be an SRS-based PHR in accordance with Equation 3:

$${PHR}_{2} = {P}_{CMAX , UE} - {P}_{SRS} \qquad ( 3 )$$

where the value P_{SRS} is the transmit power used for an SRS transmission. Additionally, or alternatively, PHR Type 3 (PHR₃) may be an configured grant-based PHR in accordance with Equation 4:

$${PHR}_{3} = {P}_{CMAX , UE} - {P}_{CG - PUSCH} \qquad ( 4 )$$

where the value P_{CG-PUSCH} is the transmit power used for a PUSCH configured grant transmission. In some examples, the PHR report 545 may include one or more PHR values respectively associated with one or more of PHR Type 1, Type 2, or Type 3. In some examples, the UE 120 may transmit the PHR report 545 to the network node 110 via the MAC layer, where the reporting behavior may be configured by the network node 110 via RRC signaling. In some examples, the network node 110 may request periodic or event-triggered PHR reports.

In some examples, a PHR value for the in-antenna-module operation may be different than a PHR value of the cross-antenna-module operation based on the value of P_{CMAX,UE} being different for in-antenna-module operation and cross-antenna-module operation. Accordingly, the PHR report 545 may indicate a first PHR metric (e.g., PHR value) associated with the cross-antenna-module operation and a second PHR metric (e.g., PHR value) associated with the in-antenna-module operation. In some examples, the first PHR metric and the second PHR metric may be sets of bits that point to a reported value from a set of reported values shown in Table 1:

TABLE 1

| Reported Value | Measured Quantity Value (dB) |
|---|---|
| POWER_HEADROOM_0 | PHR < −32 |
| POWER_HEADROOM_1 | −32 ≤ PHR < −31 |
| POWER_HEADROOM_2 | −31 ≤ PHR < −30 |
| . . . | . . . |
| POWER_HEADROOM_61 | 34 ≤ PHR < 36 |
| POWER_HEADROOM_62 | 36 ≤ PHR < 38 |
| POWER_HEADROOM_63 | PHR ≥ 38 |

As shown in Table 1, the first PHR metric and the second PHR metric may be one of 64 possible reported values that respectively map to 64 PHR ranges. Accordingly, the first PHR metric may be indicated by a first set of bits (e.g., six bits) that points to a first reported value in Table 1 and the second PHR metric may be a second set of bits (e.g., six bits) that points to a second reported value in Table 1. In some examples, the UE 120 may indicate the first PHR metric and the second PHR metric in separate PHR reports 545 (e.g., a first PHR report 545 that indicates the first PHR metric and a second PHR report 545 that indicates the second PHR metric).

In accordance with receiving the PHR report 545, the network node 110 may use the first PHR metric and the second PHR metric to determine how much additional power the UE 120 can allocate for uplink transmissions. For example, if the first PHR metric is higher than the second PHR metric, then the UE 120 may increase the allocated bandwidth or schedule more resource blocks for uplink transmissions associated with the cross-antenna-module operation compared to uplink transmissions associated with the in-antenna-module operation. Additionally, or alternatively, and in accordance with the first PHR metric and the second PHR metric, the network node 110 may adjust a first MCS for uplink transmissions associated with the cross-antenna-module operation separately from a second MCS for uplink transmissions associated with the in-antenna-module operation. Additionally, or alternatively, the network node 110 may adjust other wireless communication parameters separately for the cross-antenna-module operation and the in-antenna-module operation based on the first PHR metric and the second PHR metric (e.g., adjust one or more of uplink power control (ULPC) parameters, transmit power commands (TPCs), enabling or disabling carrier aggregation (CA), enabling or disabling dual connectivity (DC), schedule additional carriers, or reduce a number of active carriers, among other examples).

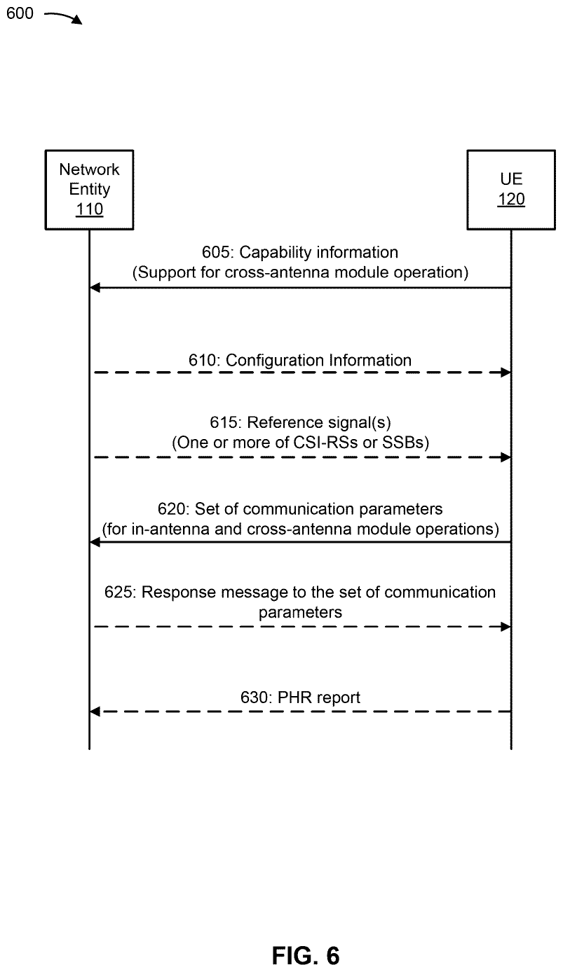

FIG. 6 is a diagram illustrating an example 600 associated with signaling that enables cross-antenna-module combining. Example 600 may implement or be implemented by one or more aspects of FIGS. 1 through 5. For instance, example 600 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 600 shows operations between the UE 120 and the network node 110, the communications may occur between any number of network devices of various types described herein.

In a first operation 605, the UE 120 may transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter to enable a cross-antenna-module operation at the UE 120. For example, the cross-antenna-module operation may be associated with wireless communications using multiple antenna elements across multiple antenna modules (e.g., the cross-antenna-module operation 325). In some examples, the capability information may indicate to enable the cross-antenna-module operation for one or more of uplink communications or downlink communications. In some examples, the capability information may indicate one or more of a data rate increase or a communication power increase for the cross-antenna-module operation relative to an in-antenna-module operation (e.g., the in-antenna-module operation 320). In some examples, the capability information may be the capability information 410 or 510, as described elsewhere herein. One or more operations described herein may be based on the capability information. For example, the UE 120 may perform one or more operations of example 600 in accordance with the capability information or may receive one or more of configuration information or control information that is in accordance with the capability information.

The network node 110 may optionally determine configuration information for the UE 120 based on the capability information. For example, the network node 110 may determine that the UE 120 is capable of operating in accordance with the cross-antenna-module operation based on the capability information.

In a second operation 610, the network node 110 may optionally transmit, and the UE 120 may receive, the configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples. In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate that the UE 120 is enabled to operate in accordance with the cross-antenna-module operation for one or more of uplink transmissions or downlink receptions. In some examples, the configuration information may indicate for the UE 120 to indicate, as part of future CSI procedures, CSI parameters associated with both the cross-antenna-module operation and the in-antenna-module operation. In some examples, the configuration information may indicate for the UE 120 to indicate, as part of future power control reports, to include power control parameters associated with both the cross-antenna-module operation and the in-antenna-module operation. In some examples, the configuration information may indicate for the UE to indicate, as part of future CSI procedures, CSI parameters associated with optimizing both spectral efficiency and energy efficiency. In some examples, the configuration information may indicate for the UE 120 to indicate, as part of future PHR reports, PHR metrics associated with both the cross-antenna-module operation and the in-antenna-module operation.

In a third operation 615, the network node 110 may optionally transmit, and the UE 120 may receive, one or more reference signals. For example, the one or more reference signals may include one or more of CSI-RSs or SSBs. In some examples, the UE 120 may receive a first reference signal via a first antenna module (e.g., the antenna module 405a or 505a) that may be associated with a first indicator (e.g., a first CRI or SSBRI). In some examples, the UE 120 may receive a second reference signal via a second antenna module (e.g., the antenna module 405b or 505b) that may be associated with a second indicator (e.g., a second CRI or SSBRI). In some examples, the one or more reference signals may be the reference signals 415 or 515, as described elsewhere herein.

In a fourth operation, the UE 120 may transmit, and the network node 110 may receive, a set of communication parameters associated with the cross-antenna-module operation and the in-antenna-module operation.

In some examples, the set of communication parameters may be included in a first CSI report (e.g., the CSI report 420). For example, the set of communication parameters may include a first set of channel state parameters, associated with the in-antenna-module operation, that indicates a first PMI, one or more first CQIs, and a first RI, and a second set of channel state parameters, associated with the cross-antenna-module operation, that indicates a second PMI, one or more second CQIs, and a second RI. In some examples, the first set of channel state parameters may be an example of channel state parameters 425a and the second set of channel state parameters may be an example of channel state parameters 425b. In some examples, the first CSI report may be associated with receiving the one or more reference signals in the third operation 615. For example, the set of communication parameters may include the first indicator (e.g., the first CRI or SSBRI) and the second indicator (e.g., the second CRI or SSBRI) based on the cross-antenna-module operation being associated with the first antenna module and the second antenna module.

In some examples, the set of communication parameters may be included in a power control report (e.g., the power control report 435). For example, the set of communication parameters may include a first set of power control parameters associated with the in-antenna-module operation and a second set of power control parameters associated with the cross-antenna-module operation. In some examples, the first set of power control parameters may be the power control parameters 440a and the second set of power control parameters may be the power control parameters 440b.

In some examples, the set of communication parameters may be included in a second CSI report (e.g., the CSI report 520). For example, the set of communication parameters may include a first set of channel state parameters associated with a first module operation, where the first module operation may be a module operation that has a higher spectral efficiency metric between the in-antenna-module operation and the cross-antenna-module operation. Additionally, the set of communication parameters may include a second set of channel state parameters associated with a second module operation, where the second module operation may be a module operation that has a higher energy efficiency metric between the in-antenna-module operation and the cross-antenna-module operation. In some examples, the first set of channel state parameters may be an example of channel state parameters 525a and the second set of channel state parameters may be an example of channel state parameters 525b. For instance, the first set of channel state parameters may indicate a first PMI, a first CQI, and a first RI, and the second set of channel state parameters may indicate a second PMI, a second CQI, and a second RI. In some examples, the set of communication parameters may additionally include a difference in energy efficiency metric associated with the first set of channel state parameters that is relative to the second set of channel state parameters (e.g., the energy efficiency difference indicator 530).

In a fifth operation 625, the network node 110 may optionally transmit, and the UE 120 may receive, a response message to the set of communication parameters. The UE 120 may receive the response message via one or more of system information signaling (e.g., a MIB or a SIB, among other examples), RRC signaling, MAC signaling (e.g., one or more MAC-CEs), or DCI, among other examples. The response message may be an example of the CSI report response 430, the power control response 445, or the CSI report response 540. In other words, the response message may indicate whether the UE 120 should operate in accordance with the in-antenna-module operation or the cross-antenna-module operation. Accordingly, the UE 120 may receive downlink transmissions or transmit uplink transmissions in accordance with the in-antenna-module operation or the cross-antenna-module operation as indicated by the response message.

In a sixth operation 630, the UE 120 may transmit, and the network node 110 may receive, a PHR report (e.g., the PHR report 545). In some examples, the PHR report may indicate a first PHR metric associated with the cross-antenna-module operation and a second PHR metric associated with the in-antenna-module operation (e.g., in accordance with Table 1). Accordingly, the network node 110 may adjust one or more parameters separately for uplink transmissions that use the in-antenna-module operation and uplink transmissions that use the cross-antenna-module operation.

FIG. 7 is a diagram illustrating an example process 700 performed, for example, at a UE or an apparatus of a UE. Example process 700 is an example where the apparatus or the UE (e.g., UE 120) performs operations associated with communication parameters in accordance with cross-antenna-module combining.

As shown in FIG. 7, in some aspects, process 700 may include transmitting, to a network node, capability information to enable a cross-antenna-module operation, where the cross-antenna-module operation is associated with wireless communications using multiple antenna elements across multiple antenna modules (block 710). For example, the UE (e.g., using transmission component 904 or communication manager 906, depicted in FIG. 9) may transmit, to a network node, capability information to enable a cross-antenna-module operation, where the cross-antenna-module operation is associated with wireless communications using multiple antenna elements across multiple antenna modules, as described above. In some aspects, transmission of the capability information may be performed in a manner similar to that described in connection with the capability information 410 of FIG. 4, the capability information 510 of FIG. 5, or the first operation 605 of FIG. 6.

As further shown in FIG. 7, in some aspects, process 700 may include transmitting, to the network node, a set of communication parameters associated with the cross-antenna-module operation and an in-antenna-module operation, where the in-antenna-module operation is associated with wireless communications using a single antenna module (block 720). For example, the UE (e.g., using transmission component 904 or communication manager 906, depicted in FIG. 9) may transmit, to the network node, a set of communication parameters associated with the cross-antenna-module operation and an in-antenna-module operation, where the in-antenna-module operation is associated with wireless communications using a single antenna module, as described above. In some aspects, transmission of the set of communication parameters may be performed in a manner similar to that described in connection with the fourth operation 620 of FIG. 6.

Process 700 may include additional aspects, such as any single aspect or any combination of aspects described below or in connection with one or more other processes described elsewhere herein.

In a first aspect, the capability information indicates to enable the cross-antenna-module operation for one or more of uplink communications or downlink communications (e.g., as described in connection with FIG. 3 through FIG. 6).

In a second aspect, the capability information indicates one or more of a data rate increase or a communication power increase for the cross-antenna-module operation relative to the in-antenna-module operation (e.g., as described in connection with FIG. 3 through FIG. 6).

In a third aspect, the set of communication parameters includes a first set of channel state parameters, associated with the in-antenna-module operation, that indicates a first PMI, one or more first CQIs, and a first RI, and a second set of channel state parameters, associated with the cross-antenna-module operation, that indicates a second PMI, one or more second CQIs, and a second RI (e.g., as described in connection with FIG. 3 through FIG. 6).

In a fourth aspect, the set of communication parameters includes a first set of power control parameters associated with the in-antenna-module operation and a second set of power control parameters associated with the cross-antenna-module operation (e.g., as described in connection with FIG. 3 through FIG. 6).

In a fifth aspect, process 700 includes receiving, from the network node via a first antenna module, a first reference signal associated with a first indicator, and receiving, from the network node via a second antenna module, a second reference signal associated with a second indicator (e.g., as described in connection with FIG. 3 through FIG. 6).

In a sixth aspect, the set of communication parameters include the first indicator and the second indicator based at least in part on the cross-antenna-module operation being associated with the first antenna module and the second antenna module (e.g., as described in connection with FIG. 3 through FIG. 6).

In a seventh aspect, the set of communication parameters includes a first set of channel state parameters associated with a first module operation, where the first module operation is a module operation that has a higher spectral efficiency metric between the in-antenna-module operation and the cross-antenna-module operation, and a second set of channel state parameters associated with a second module operation, where the second module operation is a module operation that has a higher energy efficiency metric between the in-antenna-module operation and the cross-antenna-module operation (e.g., as described in connection with FIG. 3 through FIG. 6).

In an eighth aspect, process 700 includes the first set of channel state parameters indicates a first PMI, a first CQI, and a first RI, and the second set of channel state parameters indicates a second PMI, a second CQI, and a second RI (e.g., as described in connection with FIG. 3 through FIG. 6).

In a ninth aspect, the set of communication parameters includes a difference in energy efficiency metric associated with the first set of channel state parameters that is relative to the second set of channel state parameters (e.g., as described in connection with FIG. 3 through FIG. 6).

In a tenth aspect, process 700 includes receiving, from the network node, an indication of whether one or more subsequent downlink transmissions are associated with the first set of channel state parameters or the second set of channel state parameters (e.g., as described in connection with FIG. 3 through FIG. 6).

In an eleventh aspect, process 700 includes transmitting, to the network node, a report indicating a first PHR metric associated with the cross-antenna-module operation and a second PHR metric associated with the in-antenna-module operation (e.g., as described in connection with FIG. 3 through FIG. 6).

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with communication parameters in accordance with cross-antenna-module combining.

As shown in FIG. 8, in some aspects, process 800 may include receiving, from a UE, capability information to enable a cross-antenna-module operation, where the cross-antenna-module operation is associated with wireless communications using multiple antenna elements across multiple antenna modules (block 810). For example, the network node (e.g., using reception component 1002 or communication manager 1006, depicted in FIG. 10) may receive, from a UE, capability information to enable a cross-antenna-module operation, where the cross-antenna-module operation is associated with wireless communications using multiple antenna elements across multiple antenna modules, as described above. In some aspects, reception of the capability information may be performed in a manner similar to that described in connection with the capability information 410 of FIG. 4, the capability information 510 of FIG. 5, or the first operation 605 of FIG. 6.

As further shown in FIG. 8, in some aspects, process 800 may include receiving, from the UE, a set of communication parameters associated with the cross-antenna-module operation and an in-antenna-module operation, where the in-antenna-module operation is associated with wireless communications using a single antenna module (block 820). For example, the network node (e.g., using reception component 1002 or communication manager 1006, depicted in FIG. 10) may receive, from the UE, a set of communication parameters associated with the cross-antenna-module operation and an in-antenna-module operation, where the in-antenna-module operation is associated with wireless communications using a single antenna module, as described above. In some aspects, reception of the set of communication parameters may be performed in a manner similar to that described in connection with the fourth operation 620 of FIG. 6.

Process 800 may include additional aspects, such as any single aspect or any combination of aspects described below or in connection with one or more other processes described elsewhere herein.

In a first aspect, the capability information indicates to enable the cross-antenna-module operation for one or more of uplink communications or downlink communications (e.g., as described in connection with FIG. 3 through FIG. 6).

In a second aspect, the capability information indicates one or more of a data rate increase or a communication power increase for the cross-antenna-module operation relative to the in-antenna-module operation (e.g., as described in connection with FIG. 3 through FIG. 6).

In a third aspect, the set of communication parameters includes a first set of channel state parameters, associated with the in-antenna-module operation, that indicates a first PMI, one or more first CQIs, and a first RI, and a second set of channel state parameters, associated with the cross-antenna-module operation, that indicates a second PMI, one or more second CQIs, and a second RI (e.g., as described in connection with FIG. 3 through FIG. 6).

In a fourth aspect, the set of communication parameters includes a first set of power control parameters associated with the in-antenna-module operation and a second set of power control parameters associated with the cross-antenna-module operation (e.g., as described in connection with FIG. 3 through FIG. 6).

In a fifth aspect, process 800 includes transmitting, to the UE, a first reference signal associated with a first indicator, and transmitting, to the UE, a second reference signal associated with a second indicator (e.g., as described in connection with FIG. 3 through FIG. 6).

In a sixth aspect, the set of communication parameters include the first indicator and the second indicator based at least in part on the cross-antenna-module operation being associated with a first antenna module and a second antenna module at the UE (e.g., as described in connection with FIG. 3 through FIG. 6).

In a seventh aspect, the set of communication parameters includes a first set of channel state parameters associated with a first module operation, where the first module operation is a module operation that has a higher spectral efficiency metric between the in-antenna-module operation and the cross-antenna-module operation, and a second set of channel state parameters associated with a second module operation, where the second module operation is a module operation that has a higher energy efficiency metric between the in-antenna-module operation and the cross-antenna-module operation (e.g., as described in connection with FIG. 3 through FIG. 6).

In an eighth aspect, process 800 includes the first set of channel state parameters indicates a first PMI, a first CQI, and a first RI, and the second set of channel state parameters indicates a second PMI, a second CQI, and a second RI (e.g., as described in connection with FIG. 3 through FIG. 6).

In a ninth aspect, the set of communication parameters includes a difference in energy efficiency metric associated with the first set of channel state parameters that is relative to the second set of channel state parameters (e.g., as described in connection with FIG. 3 through FIG. 6).

In a tenth aspect, process 800 includes transmitting, to the UE, an indication of whether one or more subsequent downlink transmissions are associated with the first set of channel state parameters or the second set of channel state parameters (e.g., as described in connection with FIG. 3 through FIG. 6).

In an eleventh aspect, process 800 includes receiving, from the UE, a report indicating a first PHR metric associated with the cross-antenna-module operation and a second PHR metric associated with the in-antenna-module operation (e.g., as described in connection with FIG. 3 through FIG. 6).

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3 through 6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a network node, capability information to enable a cross-antenna-module operation, where the cross-antenna-module operation is associated with wireless communications using multiple antenna elements across multiple antenna modules. The transmission component 904 may transmit, to the network node, a set of communication parameters associated with the cross-antenna-module operation and an in-antenna-module operation, where the in-antenna-module operation is associated with wireless communications using a single antenna module.

The reception component 902 may receive, from the network node via a first antenna module, a first reference signal associated with a first indicator.

The reception component 902 may receive, from the network node via a second antenna module, a second reference signal associated with a second indicator.

The reception component 902 may receive, from the network node, an indication of whether one or more subsequent downlink transmissions are associated with the first set of channel state parameters or the second set of channel state parameters.

The transmission component 904 may transmit, to the network node, a report indicating a first PHR metric associated with the cross-antenna-module operation and a second PHR metric associated with the in-antenna-module operation.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3 through 6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive, from a UE, capability information to enable a cross-antenna-module operation, where the cross-antenna-module operation is associated with wireless communications using multiple antenna elements across multiple antenna modules. The reception component 1002 may receive, from the UE, a set of communication parameters associated with the cross-antenna-module operation and an in-antenna-module operation, where the in-antenna-module operation is associated with wireless communications using a single antenna module.

The transmission component 1004 may transmit, to the UE, a first reference signal associated with a first indicator.

The transmission component 1004 may transmit, to the UE, a second reference signal associated with a second indicator.

The transmission component 1004 may transmit, to the UE, an indication of whether one or more subsequent downlink transmissions are associated with the first set of channel state parameters or the second set of channel state parameters.

The reception component 1002 may receive, from the UE, a report indicating a first PHR metric associated with the cross-antenna-module operation and a second PHR metric associated with the in-antenna-module operation.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: transmitting, to a network node, capability information to enable a cross-antenna-module operation, wherein the cross-antenna-module operation is associated with wireless communications using multiple antenna elements across multiple antenna modules; and transmitting, to the network node, a set of communication parameters associated with the cross-antenna-module operation and an in-antenna-module operation, wherein the in-antenna-module operation is associated with wireless communications using a single antenna module.
Aspect 2: The method of Aspect 1, wherein the capability information indicates to enable the cross-antenna-module operation for one or more of uplink communications or downlink communications.
Aspect 3: The method of any of Aspects 1-2, wherein the capability information indicates one or more of a data rate increase or a communication power increase for the cross-antenna-module operation relative to the in-antenna-module operation.
Aspect 4: The method of any of Aspects 1-3, wherein the set of communication parameters includes: a first set of channel state parameters, associated with the in-antenna-module operation, that indicates a first precoding matrix indicator (PMI), one or more first channel quality indicators (CQIs), and a first rank indicator (RI), and a second set of channel state parameters, associated with the cross-antenna-module operation, that indicates a second PMI, one or more second CQIs, and a second RI.
Aspect 5: The method of any of Aspects 1-4, wherein the set of communication parameters includes a first set of power control parameters associated with the in-antenna-module operation and a second set of power control parameters associated with the cross-antenna-module operation.
Aspect 6: The method of any of Aspects 1-5, further comprising: receiving, from the network node via a first antenna module, a first reference signal associated with a first indicator; and receiving, from the network node via a second antenna module, a second reference signal associated with a second indicator.
Aspect 7: The method of Aspect 6, wherein the set of communication parameters include the first indicator and the second indicator based at least in part on the cross-antenna-module operation being associated with the first antenna module and the second antenna module.
Aspect 8: The method of any of Aspects 1-7, wherein the set of communication parameters includes: a first set of channel state parameters associated with a first module operation, wherein the first module operation is a module operation that has a higher spectral efficiency metric between the in-antenna-module operation and the cross-antenna-module operation, and a second set of channel state parameters associated with a second module operation, wherein the second module operation is a module operation that has a higher energy efficiency metric between the in-antenna-module operation and the cross-antenna-module operation.
Aspect 9: The method of Aspect 8, wherein: the first set of channel state parameters indicates a first precoding matrix indicator (PMI), a first channel quality indicator (CQI), and a first rank indicator (RI), and the second set of channel state parameters indicates a second PMI, a second CQI, and a second RI.
Aspect 10: The method of Aspect 8, wherein the set of communication parameters includes a difference in energy efficiency metric associated with the first set of channel state parameters that is relative to the second set of channel state parameters.
Aspect 11: The method of Aspect 8, further comprising: receiving, from the network node, an indication of whether one or more subsequent downlink transmissions are associated with the first set of channel state parameters or the second set of channel state parameters.
Aspect 12: The method of any of Aspects 1-11, further comprising: transmitting, to the network node, a report indicating a first power headroom (PHR) metric associated with the cross-antenna-module operation and a second PHR metric associated with the in-antenna-module operation.
Aspect 13: A method of wireless communication performed by a network node, comprising: receiving, from a user equipment (UE), capability information to enable a cross-antenna-module operation, wherein the cross-antenna-module operation is associated with wireless communications using multiple antenna elements across multiple antenna modules; and receiving, from the UE, a set of communication parameters associated with the cross-antenna-module operation and an in-antenna-module operation, wherein the in-antenna-module operation is associated with wireless communications using a single antenna module.
Aspect 14: The method of Aspect 13, wherein the capability information indicates to enable the cross-antenna-module operation for one or more of uplink communications or downlink communications.
Aspect 15: The method of any of Aspects 13-14, wherein the capability information indicates one or more of a data rate increase or a communication power increase for the cross-antenna-module operation relative to the in-antenna-module operation.
Aspect 16: The method of any of Aspects 13-15, wherein the set of communication parameters includes: a first set of channel state parameters, associated with the in-antenna-module operation, that indicates a first precoding matrix indicator (PMI), one or more first channel quality indicators (CQIs), and a first rank indicator (RI), and a second set of channel state parameters, associated with the cross-antenna-module operation, that indicates a second PMI, one or more second CQIs, and a second RI.
Aspect 17: The method of any of Aspects 13-16, wherein the set of communication parameters includes a first set of power control parameters associated with the in-antenna-module operation and a second set of power control parameters associated with the cross-antenna-module operation.
Aspect 18: The method of any of Aspects 13-17, further comprising: transmitting, to the UE, a first reference signal associated with a first indicator; and transmitting, to the UE, a second reference signal associated with a second indicator.
Aspect 19: The method of Aspect 18, wherein the set of communication parameters include the first indicator and the second indicator based at least in part on the cross-antenna-module operation being associated with a first antenna module and a second antenna module at the UE.
Aspect 20: The method of any of Aspects 13-19, wherein the set of communication parameters includes: a first set of channel state parameters associated with a first module operation, wherein the first module operation is a module operation that has a higher spectral efficiency metric between the in-antenna-module operation and the cross-antenna-module operation, and a second set of channel state parameters associated with a second module operation, wherein the second module operation is a module operation that has a higher energy efficiency metric between the in-antenna-module operation and the cross-antenna-module operation.
Aspect 21: The method of Aspect 20, wherein: the first set of channel state parameters indicates a first precoding matrix indicator (PMI), a first channel quality indicator (CQI), and a first rank indicator (RI), and the second set of channel state parameters indicates a second PMI, a second CQI, and a second RI.
Aspect 22: The method of Aspect 20, wherein the set of communication parameters includes a difference in energy efficiency metric associated with the first set of channel state parameters that is relative to the second set of channel state parameters.
Aspect 23: The method of Aspect 20, further comprising: transmitting, to the UE, an indication of whether one or more subsequent downlink transmissions are associated with the first set of channel state parameters or the second set of channel state parameters.
Aspect 24: The method of any of Aspects 13-23, further comprising: receiving, from the UE, a report indicating a first power headroom (PHR) metric associated with the cross-antenna-module operation and a second PHR metric associated with the in-antenna-module operation.
Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.
Aspect 26: An apparatus for wireless communication at a device, the apparatus comprising one or more memories and one or more processors coupled to the one or more memories, the one or more processors configured to cause the device to perform the method of one or more of Aspects 1-24.
Aspect 27: An apparatus for wireless communication, the apparatus comprising at least one means for performing the method of one or more of Aspects 1-24.
Aspect 28: A non-transitory computer-readable medium storing code for wireless communication, the code comprising instructions executable by one or more processors to perform the method of one or more of Aspects 1-24.
Aspect 29: A non-transitory computer-readable medium storing a set of instructions for wireless communication, the set of instructions comprising one or more instructions that, when executed by one or more processors of a device, cause the device to perform the method of one or more of Aspects 1-24.
Aspect 30: A device for wireless communication, the device comprising a processing system that includes one or more processors and one or more memories coupled with the one or more processors, the processing system configured to cause the device to perform the method of one or more of Aspects 1-24.
Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.
Aspect 32: A device comprising a processing system that includes one or more processors and one or more code-storing memories coupled with the one or more processors, the processing system configured to cause the device to perform the method of one or more of Aspects 1-24.
Aspect 33: A device comprising a processing system that includes processor circuitry and code-storing memory circuitry, the processing system configured to cause the device to perform the method of one or more of Aspects 1-24.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “ir response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
transmit, to a network node, capability information to enable a cross-antenna-module operation, wherein the cross-antenna-module operation is associated with wireless communications using multiple antenna elements across multiple antenna modules; and
transmit, to the network node, a set of communication parameters associated with the cross-antenna-module operation and an in-antenna-module operation, wherein the in-antenna-module operation is associated with wireless communications using a single antenna module.

2. The UE of claim 1, wherein the capability information indicates to enable the cross-antenna-module operation for one or more of uplink communications or downlink communications.

3. The UE of claim 1, wherein the capability information indicates one or more of a data rate increase or a communication power increase for the cross-antenna-module operation relative to the in-antenna-module operation.

4. The UE of claim 1, wherein the set of communication parameters includes:
a first set of channel state parameters, associated with the in-antenna-module operation, that indicates a first precoding matrix indicator (PMI), one or more first channel quality indicators (CQIs), and a first rank indicator (RI), and
a second set of channel state parameters, associated with the cross-antenna-module operation, that indicates a second PMI, one or more second CQIs, and a second RI.

5. The UE of claim 1, wherein the set of communication parameters includes a first set of power control parameters associated with the in-antenna-module operation and a second set of power control parameters associated with the cross-antenna-module operation.

6. The UE of claim 1, wherein the one or more processors individually or collectively are configured to:
receive, from the network node via a first antenna module, a first reference signal associated with a first indicator; and
receive, from the network node via a second antenna module, a second reference signal associated with a second indicator.

7. The UE of claim 6, wherein the set of communication parameters include the first indicator and the second indicator based at least in part on the cross-antenna-module operation being associated with the first antenna module and the second antenna module.

8. The UE of claim 1, wherein the set of communication parameters includes:
a first set of channel state parameters associated with a first module operation, wherein the first module operation is a module operation that has a higher spectral efficiency metric between the in-antenna-module operation and the cross-antenna-module operation, and
a second set of channel state parameters associated with a second module operation, wherein the second module operation is a module operation that has a higher energy efficiency metric between the in-antenna-module operation and the cross-antenna-module operation.

9. The UE of claim 8, wherein:
the first set of channel state parameters indicates a first precoding matrix indicator (PMI), a first channel quality indicator (CQI), and a first rank indicator (RI), and
the second set of channel state parameters indicates a second PMI, a second CQI, and a second RI.

10. The UE of claim 8, wherein the set of communication parameters includes a difference in energy efficiency metric associated with the first set of channel state parameters that is relative to the second set of channel state parameters.

11. The UE of claim 8, wherein the one or more processors individually or collectively are configured to:
receive, from the network node, an indication of whether one or more subsequent downlink transmissions are associated with the first set of channel state parameters or the second set of channel state parameters.

12. The UE of claim 1, wherein the one or more processors individually or collectively are configured to:
transmit, to the network node, a report indicating a first power headroom (PHR) metric associated with the cross-antenna-module operation and a second PHR metric associated with the in-antenna-module operation.

13. A method of wireless communication performed by a user equipment (UE), comprising:
transmitting, to a network node, capability information to enable a cross-antenna-module operation, wherein the cross-antenna-module operation is associated with wireless communications using multiple antenna elements across multiple antenna modules; and
transmitting, to the network node, a set of communication parameters associated with the cross-antenna-module operation and an in-antenna-module operation, wherein the in-antenna-module operation is associated with wireless communications using a single antenna module.

14. The method of claim 13, wherein the capability information indicates to enable the cross-antenna-module operation for one or more of uplink communications or downlink communications.

15. The method of claim 13, wherein the capability information indicates one or more of a data rate increase or a communication power increase for the cross-antenna-module operation relative to the in-antenna-module operation.

16. The method of claim 13, wherein the set of communication parameters includes:
a first set of channel state parameters, associated with the in-antenna-module operation, that indicates a first precoding matrix indicator (PMI), one or more first channel quality indicators (CQIs), and a first rank indicator (RI), and a second set of channel state parameters, associated with the cross-antenna-module operation, that indicates a second PMI, one or more second CQIs, and a second RI.

17. The method of claim 13, wherein the set of communication parameters includes a first set of power control parameters associated with the in-antenna-module operation and a second set of power control parameters associated with the cross-antenna-module operation.

18. The method of claim 13, further comprising:
receiving, from the network node via a first antenna module, a first reference signal associated with a first indicator; and
receiving, from the network node via a second antenna module, a second reference signal associated with a second indicator.

19. The method of claim 18, wherein the set of communication parameters include the first indicator and the second indicator based at least in part on the cross-antenna-module operation being associated with the first antenna module and the second antenna module.

20. An apparatus for wireless communication, comprising:
means for transmitting, to a network node, capability information to enable a cross-antenna-module operation, wherein the cross-antenna-module operation is associated with wireless communications using multiple antenna elements across multiple antenna modules; and
means for transmitting, to the network node, a set of communication parameters associated with the cross-antenna-module operation and an in-antenna-module operation, wherein the in-antenna-module operation is associated with wireless communications using a single antenna module.
